(19) United States
(12) Patent Application Publication
(10) Pub. No.: US 2008/0235736 A1
(43) Pub. Date: Sep. 25, 2008

(54) System and method for dynamic updating of TV menu

(76) Inventors: Thomas Patrick Dawson, Escondido, CA (US); Ludovic Douillet, Escondido, CA (US); Takashi Hironaka, San Diego, CA (US); Rajesh Kechal Rao, San Marcos, CA (US); George Edward Williams, Carlsbad, CA (US)

Correspondence Address: ROGITZ & ASSOCIATES, 750 B STREET, SUITE 3120, SAN DIEGO, CA, 92101, US

(21) Appl. No.: 11/726,558

(22) Filed: Mar. 22, 2007

(51) Int. Cl. H04N 7/025

(52) U.S. Cl. 725/50

(57) ABSTRACT

When a new device such as a set-back box (SBB) connects to a TV, the menu of the TV is dynamically updated with an icon and an application identification associated with the new device, so that a viewer can select the new device from the menu.

### FIELD OF THE INVENTION

The present invention relates generally to dynamically updating TV menus.

### BACKGROUND OF THE INVENTION

TVs present menus that show various applications that can be accessed through the TVs. An application on the menu can be selected by a viewer by means of manipulating a remote control to point at and select the desired application.

As understood herein, current TV menus are static, in that the menu items are predefined before shipping. As further understood herein, advanced TV systems provide a constellation of devices that can be connected to the TV to enhance the TV's features. However, as mentioned above, in the current TV menu architecture the TV must be programmed before vending the TV with the identities of all such features in order to place them on the menu since the menus are static. As recognized herein, it is possible that an end user might wish to add devices to the TV after the TV has been sold, and the devices may not have been foreseen at the time of vending (and, hence, would not have been provided for on the menu). Therefore, as understood herein it would be desirable to add previously unforeseen application information to a TV menu.

### SUMMARY OF THE INVENTION

A menu listing categories of entertainment available for presentation is displayed on a TV. Subsequently, a component such as a disk player, Internet adapter, etc. can be connected to the TV by an end user. The component provides access to one or more applications. Application information is sent from the component to the TV, with the application information including an application label associated with the application, an application identification associated with the application, and an icon associated with the application. The icon and application label are added to the menu, which also includes other application icons and labels as well. A user can select an application from the menu to invoke the application for display on the TV, which is accomplished by sending the application identification to the component.

In another aspect, a TV system includes a TV display, a TV processor, and logic accessible to the TV processor for receiving application information from an application sought to be added to the TV. The TV uses the application information to modify a menu presented on the TV.

The application information may include an application label that is presented in a user-defined language. Also, the application information may include an application identification and an icon associated with the application and displayable on the TV along with the application label. The TV processor need not know the context of the application, such that when a user selects the application from the menu, the TV need only send an application identification to the application to invoke the application. If desired, the application information can be conveyed in XML format.

In yet another aspect, a TV has a display and a processor presenting a menu on the display. The menu contains icons representing entertainment content categories, and the menu can be dynamically updated by the processor to reflect the addition of new applications available for presentation on the display. The menu likewise can be dynamically updated by the processor to reflect the removal of applications.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting TV system in accordance with present principles;

FIG. 2 is a flow diagram showing non-limiting logic for dynamic TV menu updating; and

FIG. 3 is a non-limiting example of a dynamically menu implemented as a cross-media bar (“XMB”) that can be presented on the TV.

### DETAILED DESCRIPTION OF THE PREFERRED EMBODIMENT

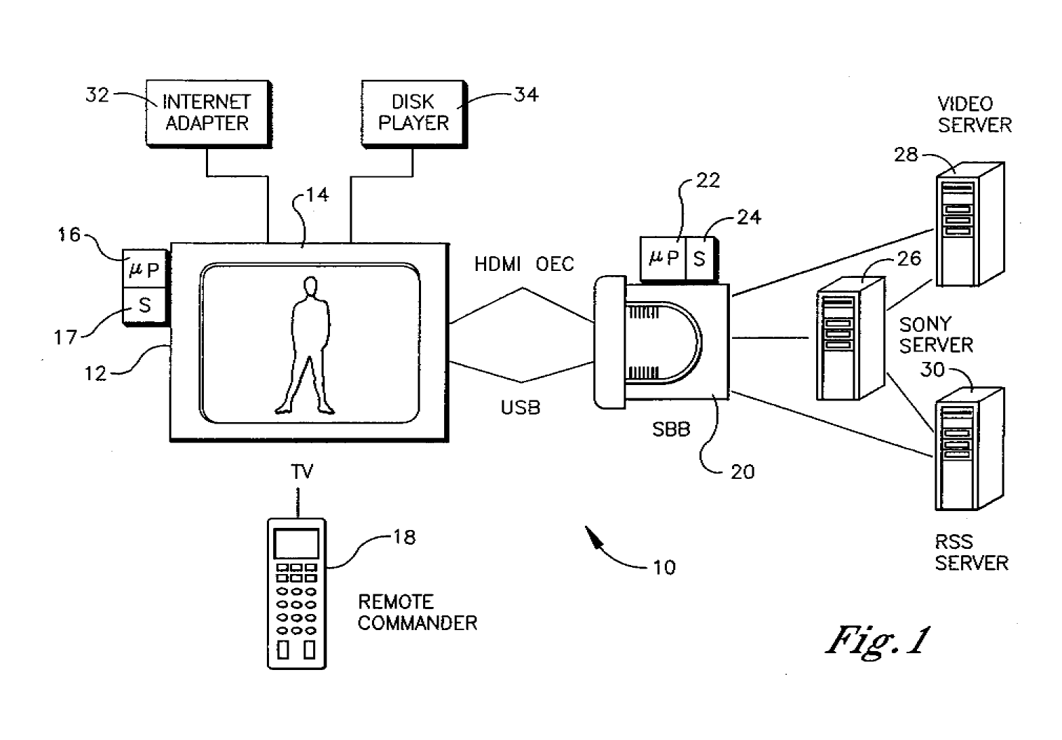

Referring initially to FIG. 1, a system is shown, generally designated 10, which includes a TV 12 having a TV display 14 and a TV processor 16. The processor 16 can access a computer-readable medium 17 such as disk storage or solid state storage to execute logic contained in the medium 17. A viewer can control the TV 12 by means of manipulating a wireless remote control 18.

FIG. 1 shows that one or more components may communicate with the TV 12. By way of non-limiting example, a set-back box (SBB) 20 can communicate with the TV 12 using both high definition multimedia interface (HDMI) principles and universal serial bus (USB) communication principles as shown. The SBB 20 may include a SBB processor 22 that can access a computer-readable medium 24 such as disk storage or solid state storage to execute logic contained in the medium 24. The medium 24 can also contain one or more software applications, each providing its own source of entertainment for display on the TV 12.

As indicated in FIG. 1, the SBB 20 may provide content to the TV 12 from plural sources, each being associated with its own application. For example, the SBB 20 may provide the TV 12 with content from a TV manufacturer server 26 that communicates with the SBB 20 over the Internet or other communication medium such as a cable modem or satellite. Likewise, the SBB 20 may provide the TV 12 with content from a video server 28 that communicates with the SBB 20 and/or from a RSS server 30 that also communicates content such as podcasts to the SBB 20.

Additional examples of components that can be connected to the TV 12 and cause the TV menu to be dynamically updated as discussed below include an Internet TV adapter 32 with its own processor. The adapter 32 can be connected to the TV 12 and to the Internet to enable the TV 12 to communicate directly to the Internet. The Internet adapter 32 sends application identifications that are associated with icon data as set forth further below, so that the TV menu described below can display internet video menu items such as “Yahoo”, “Google”, etc. on the menu.

Another example of a component that can be connected to the TV 12 and cause the TV menu to be dynamically updated as discussed below is a disk player 34 such as but not limited to a DVD player or BluRay player, which can also have its own internal processor. When the disk player 34 is attached to the TV and a disk is inserted to the player 34, a disk icon with application identification is sent to the TV 12 so that the below-described menu can be dynamically updated such that the TV 12 displays a disk icon under a “video” category icon. As described further below, when a user selects the disk icon on the menu, the application ID that is associated with the icon is sent to the disk player 34, and in response the player 34 can play the disk.

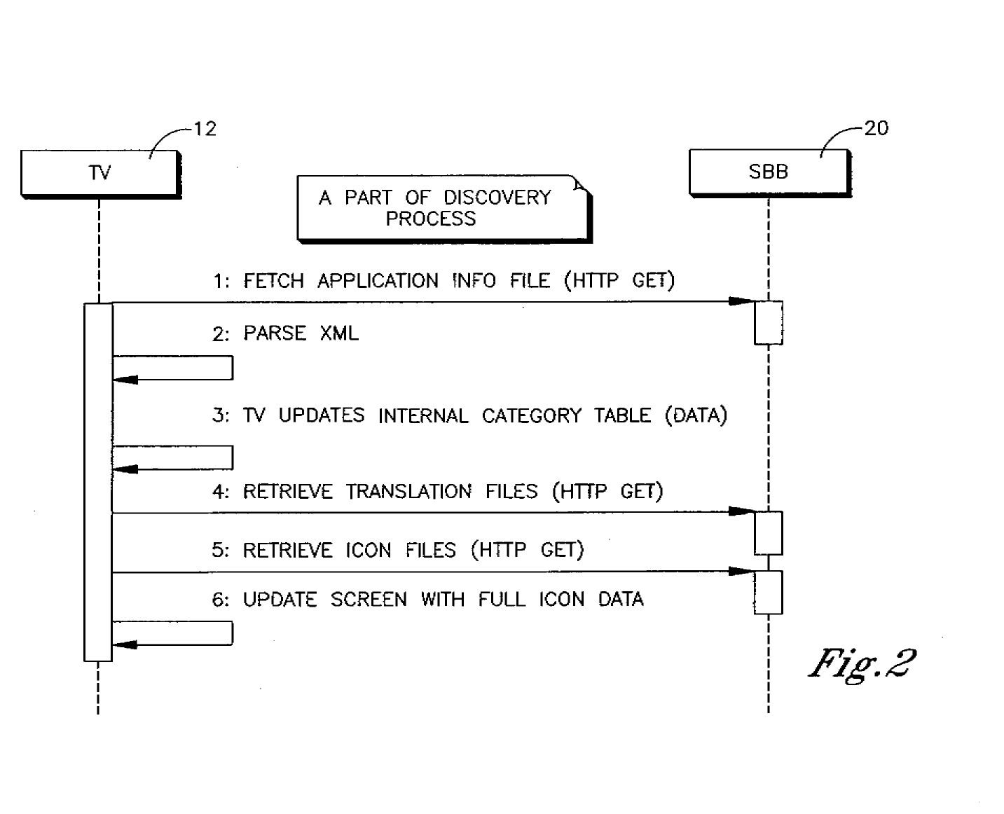

Now referring to FIG. 2, the logic of the system 10 in dynamically updating a menu presented on the TV from which a viewer can select an application is shown. The logic can be executed by one or more of the processors discussed above.

Commencing at state “1” in FIG. 2, the TV 12 can query the SBB 20 (or Internet adapter 32 or disk player 34) for application information using, e.g., a hypertext transfer protocol (HTTP) “get” request. It is to be understood that alternatively, the SBB 20 or other component can automatically push application information to the TV 12 upon addition of the new application without being requested to do so by the TV.

At state “2” and taking the SBB 20 as an example component, the SBB 20 sends the requested application information to the TV 12 in, e.g., XML format, which is parsed by the TV 12 to extract the application information. In some implementations the application information may include an application label, an application identification, an application icon location to be used in placing the icon on the TV menu, and an application order for ordering the applications on the TV menu. As set forth further below, the application label can have the name of the application in different languages so that the TV can display the application name in the user's choice language.

Using the parsed information from step “2” the TV 12 reconstructs the TV menu at state “3” by, e.g., updating an internal category table that is used as the menu representation. At state “4” the TV 12 can retrieve (alternatively, can be automatically provided) translation files from the SBB 20 so that the application label may be presented on the TV in the language chosen by the viewer.

At state “5” the files representing the icon(s) of the application(s) to be added to the menu may be retrieved (alternatively, can be automatically provided) from the SBB 20 in embodiments wherein the menu presents not just an application label in alpha-numeric format but an icon as well for each application. The icon data is retrieved from the location that is specified in the application information, since the TV 12 does not know the context of the newly added application. With the application information now fully in hand, at state “6” the TV displays the newly added application labels and icons on the menu along with the previous icons and labels. It is to be understood that in the same way, the TV menu is dynamically updated with application information from the Internet adapter 32, disk player 34, and other components.

It may now be appreciated that the linkage between a TV menu item and an added application is the application identification, with all the menu items being described by the above-mentioned application information. When the user selects an icon on the menu, the TV 12 sends the application ID to the application host (via, e.g., the SBB 20). The application ID is unique so that the correct application that the user selected can be invoked.

It may now be appreciated that the application information on the TV menu can be updated dynamically, so that when the application items that are available change, the application information is simply sent to the TV 12, which reconstructs the menu on the fly. Furthermore, because the application information can be in XML format, the application information can be used not only to update the TV menu, but also to update any other devices such as game consoles that can use the application information.

The actual behavior of each menu item can be implemented either in the SBB 20 or in the TV 12. If desired, applications can be periodically polled by the TV 12 to ensure they are still available and if an application does not respond, its icon and label can be removed from the TV menu.

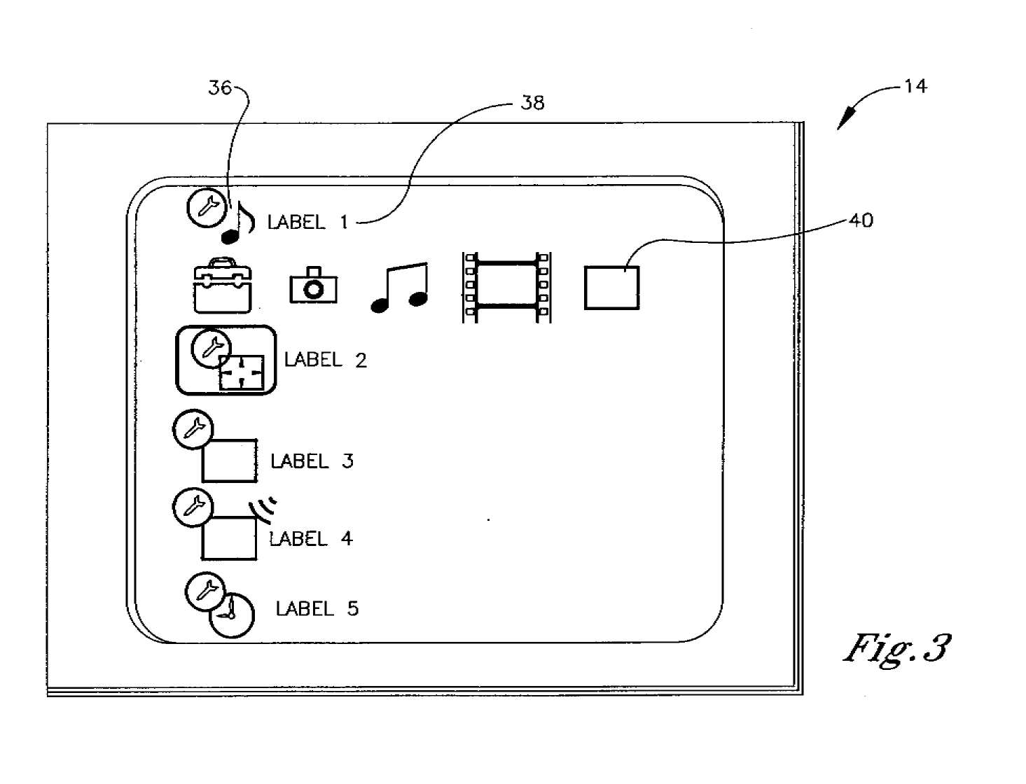

FIG. 3 shows a non-limiting implementation of a menu that can be presented on the TV display 14. The implementation shown in FIG. 3 is colloquially referred to as a “cross media bar” or “XMB”. As shown, plural icons 36 are presented in an ordered list, with associated alpha-numeric application labels 38 presented next to at least some of the icons 36 as shown. The icons 36 may be category icons, indicating, e.g., “video”, “music”, etc., and sub-icons 40 representing applications within a category (such as the name of a movie on a disk in the disk player 40, which would appear to the right of the “video” icon) can be arranged in a row with the category icon 36 in the left-hand end of the row. Other icon arrangements and layouts can be used.

While the particular SYSTEM AND METHOD FOR DYNAMIC UPDATING OF TV MENU is herein shown and described in detail, it is to be understood that the subject matter which is encompassed by the present invention is limited only by the claims.

What is claimed is:

1. A TV system comprising:
a TV display;
a TV processor; and
logic accessible to the TV processor for receiving application information from an application sought to be added to the TV, the TV using the application information to modify at least one menu presented on the TV.

2. The system of claim 1, wherein the application information includes an application label.

3. The system of claim 2, wherein the label is presented in a user-defined language.

4. The system of claim 3, wherein the application information includes an application identification.

5. The system of claim 4, wherein the application information includes an icon associated with the application and displayable on the TV along with at least the application label.

6. The system of claim 1, wherein the TV processor does not know the context of the application.

7. The system of claim 6, wherein when a user selects the application from the menu, the TV sends an application identification to the application to invoke the application.

8. The system of claim 1, wherein the application information is conveyed in XML format.

9. A TV comprising:
a display; and
a processor presenting a menu on the display, the menu containing at least icons representing entertainment content categories, the menu being dynamically updated by the processor to reflect the addition of new applications available for presentation on the display.

10. The TV of claim 9, wherein the menu is dynamically updated by the processor to reflect the removal of applications.

11. The TV of claim 9, wherein the menu is dynamically updated based at least in part on application information received from applications sought to be added.

12. The TV of claim 11, wherein the application information includes an application label.

13. The TV of claim 12, wherein the label is presented in a user-defined language.

14. The TV of claim 13, wherein the application information includes an application identification.

15. The TV of claim 14, wherein the application information includes an icon associated with the application and displayable on the TV along with at least the application label.

16. The TV of claim 9, wherein the processor does not know the context of the applications.

17. The TV of claim 16, wherein when a user selects an application from the menu, the TV sends an application identification to the application to invoke the application.

18. The TV of claim 11, wherein the application information is conveyed in XML format.

19. A method comprising:
displaying a menu on a TV display, the menu listing categories of entertainment available for presentation on the TV;
connecting a component to the TV, the component providing access to at least one application;
sending application information from the component to the TV, the application information including at least an application label associated with the application, an application identification associated with the application, and an icon associated with the application;
adding the icon and application label to a menu displayable on the TV, the menu including other application icons and labels;
permitting a user to select an application from the menu; and
in response to a user selecting an application from the menu, invoking the application for display on the TV by sending the application identification to the component.

20. The method of claim 19, wherein the label is presented in a user-defined language.
